(19) United States
(12) Patent Application Publication
(10) Pub. No.: US 2017/0221163 A1
(43) Pub. Date: Aug. 3, 2017

(54) CREATE A HETEROGENEOUS LEARNER GROUP

(71) Applicant: Hewlett-Packard Development Company, L.P., Houston, TX (US)

(72) Inventors: Lei Liu, Palo Alto, CA (US); Georgia Koutrika, Palo Alto, CA (US); Jerry Liu, Palo Alto, CA (US)

(73) Assignee: Hewlett-Packard Development Company, L.P., Hoston, TX (US)

(21) Appl. No.: 15/500,917

(22) PCT Filed: Jul. 31, 2014
(86) PCT No.: PCT/US2014/049041

§ 371 Date: Jan. 31, 2017

(51) Int. Cl. G06Q 50/20; G09B 5/08; G09B 7/02; G06Q 10/06; G06Q 10/10

(52) U.S. Cl. CPC G06Q 50/20; G06Q 10/063112; G06Q 10/103; G09B 7/02; G09B 5/08; G09B 5/00

(57) ABSTRACT

Examples disclosed herein relate to creating a heterogeneous learner group. In one implementation, a processor associates a selected learner with a group of learners based on a value of a factor associated with the group of learners compared to a value of the factor associated with the selected learner. For example, the value associated with the selected learner may be indicative of a strength compared to the value associated with the group of learners. The processor may output information related to a heterogeneous learner group created from the group of learners and the selected learner.

### BACKGROUND

Students may be placed in learning groups, for example, to attend a particular class or lecture, to work on a group project, or study for an exam. The students may benefit from the knowledge and experience of other students in the group.

### BRIEF DESCRIPTION OF THE DRAWINGS

The drawings describe example embodiments. The following detailed description references the drawings, wherein:

FIG. 1 is a block diagram illustrating one example of a computing system to create a heterogeneous learner group.

FIG. 2 is a flow chart illustrating one example o a method to create a heterogeneous learner group.

FIG. 3 is a block diagram illustrating one example of a computing system to create a heterogeneous learner group based on historical performance data.

FIG. 4 is a flow chart illustrating one example of a method to create a heterogeneous learner group based on historical performance data.

FIG. 5 is a diagram illustrating one example of creating a heterogeneous learner group based on historical performance data.

FIG. 6 is a diagram illustrating one example of creating a heterogeneous learner group from a homogeneous learner group.

### DETAILED DESCRIPTION

In one implementation, a processor automatically creates a heterogeneous learner group by adding a learner to a learning group such that the added learner is identified based on his ability to address a weakness associated with the group. For example, the processor may apply a clustering method to a set of learners to group the learners together based on a set of factors. The set of factors may be further analyzed to determine a weakness in the factor values associated with the group, and the values of the factors associated with the group compared to the values of the factors associated with the additional learner. The additional learner may be added to the group to create a heterogeneous learner group.

The factors used to select the additional learner may be related to historical performance data. For example, a score below a threshold may be associated with the group, and an additional learner selected to join the group may have a score above a threshold, or vice versa. The score may be, for example, a correct answer to a question or an overall performance grade in a subject area.

In one implementation, a heterogeneous learner group is automatically created from a homogeneous learner group. For example, a processor may cluster a group of learners based on the degree of commonality of factors associated with the individuals in the group and select a learner to join the group based on a degree of difference related to the factors associated with the group.

Heterogeneous learning groups may allow learners in a group to learn more based on the way the learners may help one another. Automatically creating a heterogeneous learner group may provide advantages in a learning environment, such as by allowing a teacher to set criteria and automatically receive a list of recommended heterogeneous learning groups that meet the criteria from a large set of individual learners.

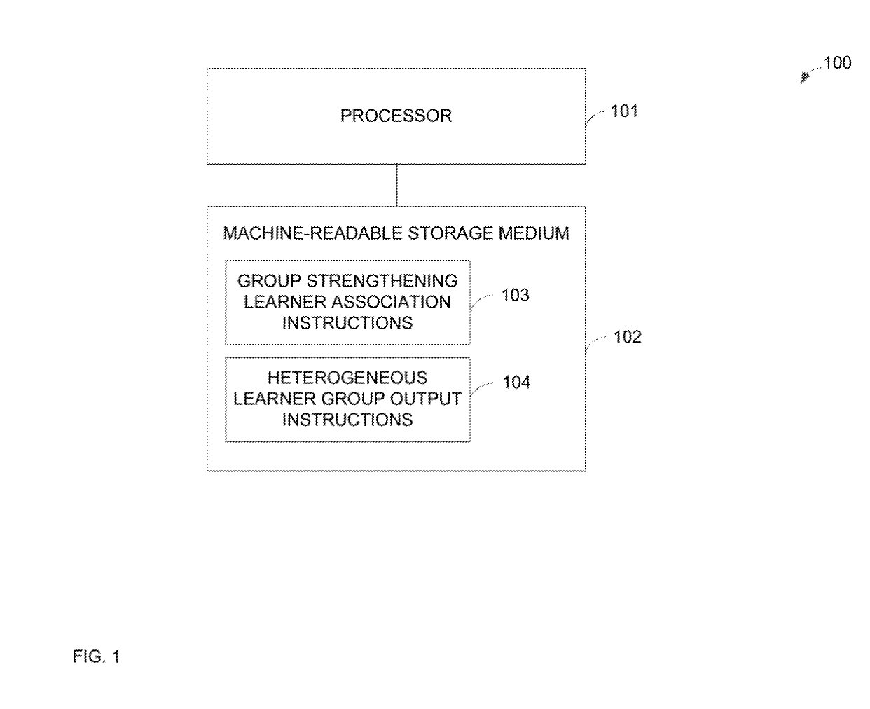

FIG. 1 is a block diagram illustrating one example of a computing system 100 to create a heterogeneous learner group. For example, the computing system 100 may automatically create a group of learners such that the learners have different strengths and weaknesses. The computing system 100 may use any suitable type of data to create the group, such as performance data or study habit data. The computing system 100 includes a processor 101 and a machine-readable storage medium 102.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions executable by the processor 101, such as group strengthening learner association instructions 103 and heterogeneous learner group output instructions 104.

The group strengthening learner association instructions 103 includes instructions to select a learner to add to a learner group based on the ability of the selected learner to strengthen the group. For example, a selected learner may be associated with the group of learners based on a value of a factor associated with the group of learners compared to a value of the factor associated with the selected learner. The selected learner may be a leader learner selected to provide a strength to the group. For example, the value associated with the selected learner may be indicative of a strength compared to the value associated with the group of learners.

In some cases, multiple additional learners may provide a strength to the group of learners, and a learner may be selected from the set of additional learners based on the degree of strength of the additional learner, difference in the factor value compared to the group of learners. In some implementations, multiple factors are used, and the number of strengths or the weight of the factors addressed is used to select a learner from the set of potential learners to add to the group.

The heterogeneous learner group output instructions 104 include instructions to create a heterogeneous group by adding the selected learner to the learning group and outputting information about the heterogeneous learner group. For example, information about the heterogeneous group may be transmitted, stored, or displayed. In one implementation, multiple heterogeneous groups are created, and a user interface is provided to allow a user to select one or more of the created groups. In one implementation multiple heterogeneous groups are created based on a criteria, such as the number of learners per group, and the potential groups are ranked relative to one another such that the a subset of the potential groups with a ranking above a threshold are output for recommendation.

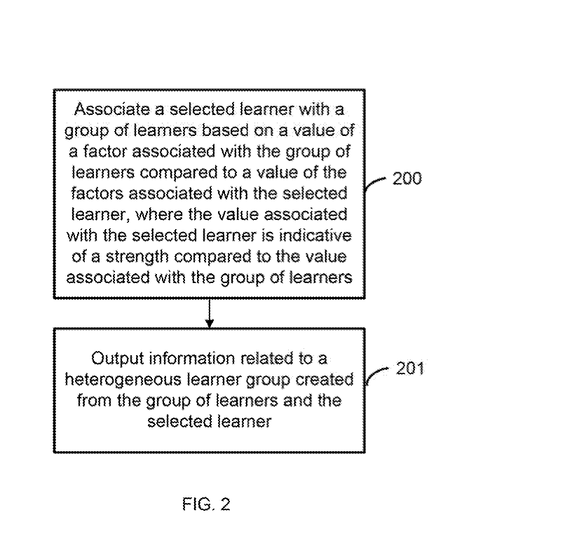

FIG. 2 is a flow chart illustrating one example of a method to create a heterogeneous learner group. The learning group may be created for any suitable purpose, such as for formal education, professional training, or learning a new skill. The heterogeneous learner group may be automatically created to include a least one leader learner to address a weakness of the other group members. The method may be implemented, for example, by the processor 101 of FIG. 1.

Beginning at 200, a processor associates a selected learner with a group of learners based on a value of a factor associated with the group of learners compared to a value of the factors associated with the selected learner. For example, the value associated with the selected learner may be indicative of a strength compared to the value associated with the group of learners.

The learner may be selected according to any suitable method. For example, a pool of learners may be considered for adding to the group. In one implementation, multiple potential groups may be created by adding different learners to the group. The different groups may be scored, and the scores may be compared to determine a group or set of groups to recommend. The processor may perform a recursive strategy. For example, at each round, the processor may select a learner found to optimally address the weakness of the group, such as based on a comparative group score of the group Including the selected, learner, and/or selecting a learner that marginally addresses the weakness of the group, such as based on a comparative group score with the lowest score above a threshold. one implementation, multiple methods are performed to create potential learners to add to the group. Information about the potential groups may be provided to a user to select from the proposed groups and/or the processor may select between the proposed groups based on additional factors.

The processor may receive information about the group of earners, such as from a storage. In one implementation, the processor creates the group of learners. The processor may create the group of learners using any suitable method, such as a clustering method. The group of learners may be grouped together to be similar or diverse, such as a group with similar study habits or different study habits. The groups may be created based on any suitable factors. For example, the group may be created from historical performance data such that the group is created to make the historical performance data similar. In some implementations, the learner group clustering instructions include instructions to create multiple learning groups such that the same learner may be in one group, or in some cases multiple groups.

The processor associates a selected learner with the group of learners based on values of the factors associated with the members of the group compared to values of the factors associated with the selected learner. For example, the leader learner may be selected to address a weakness associated with the group of learners. The steps may be performed in any suitable order. For example, in one implementation, a processor selects a leader learner and then selects a group of learners to learn from the leader learner.

In one implementation, a value associated with the group is below a threshold and a value associated with the leader is above a threshold or vice versa. For example, the threshold may be used to indicate whether a value is indicative of a strength or weakness. In some cases, the learners may be ranked. For example, a weakness may be identified for a group of learners, and a learner with a score in the area in the top N or top X percent may be determined to be a strength, In one implementation, the processor determines multiple factors indicative of a weaknesses and selects the learner based on the number of factors and/or weight of the factors indicative of a weaknesses addressed by the selected learner. In one implementation, historical performance data is used to select the leader learner. For example, the correctness of an answer to a particular test question, the correctness of an answers to a set of test questions, a test score, and/or a performance evaluation score may be used.

The factors used to create the group may be the same or different than those used to select the leader learner. For example, a homogeneous group may be selected based on the study habits of the learners within the group, and a leader learner may be selected to join the group based on historical performance data associated with the group compared to the leader learner.

The processor may use multiple pieces of selection criteria. For example, a factor in addition to the relative strength of the selected learner may be applied that relates to the leader learner and the group. The processor may apply constraints related to how the heterogeneous group fits into a context of groups, such as based on user provided criteria. For example, the processor may select the leader and/or the heterogeneous group based on the size of the heterogeneous group, the uniqueness of membership of the heterogeneous group, the number of additional learners added to the heterogeneous groups, and a comparison of the heterogeneous group to other potential heterogeneous groups.

In one implementation, multiple selected learners may be added to a group, such that they address the same or different factors. For example, one learner may be selected to join because of a strength in science and another may be selected because of a strength in mathematics.

In one implementation, the heterogeneous group is created based on additional criteria. The additional criteria may be determined by the processor and/or determined based on user input. For example, the criteria may include the size of the heterogeneous group, the uniqueness of membership of the heterogeneous group, the number of additional learners added to the heterogeneous groups, and a comparison of the heterogeneous group to other heterogeneous groups. The additional criteria may include a degree of reciprocity. For example, a second factor may be considered where the value of the second factor associated with the selected learner is indicative of a weakness compared to the value associated with the group of learners.

In one implementation, the method is an iterative process. For example, learners may be grouped based on a weakness determined based on historical performance data, such as creating a first group with a weakness in reading and a second group with a weakness in science. The processor may attempt to identify a learner that addresses a weakness associated with the group. In some cases, a learner that addresses the weakness is not available and/or a group created with an available learner has a desirability score below a threshold, such as because the learner does not adequately address the weakness, create a reciprocity score above a threshold, and/or result in an overall strength score associated with the group above a threshold. The processor may re-group the learners, such as using a different method or based on different factors, and attempt to select learners to associate with the new groups. In one implementation, if a learner is not identified, the processor generates a user interface to request that the user update the grouping and/or learner selection criteria, and the processor may perform the method again with the updated criteria.

Continuing to 202, a processor outputs information related to a heterogeneous learner group created from the group of learners and the selected learner. For example, the processor may create the heterogeneous group by adding the leader learner to the group of learners. The processor may create multiple heterogeneous group options and select an option to present to a user based on a set of properties associated with the heterogeneous groups. The information about the heterogeneous group may be output in any suitable manner, such as by information related to the group being displayed, transmitted, or stored. In one implementation, the processor selects and/or creates content based on the heterogeneous group, such as content tailored to the particular strength and weaknesses of the group.

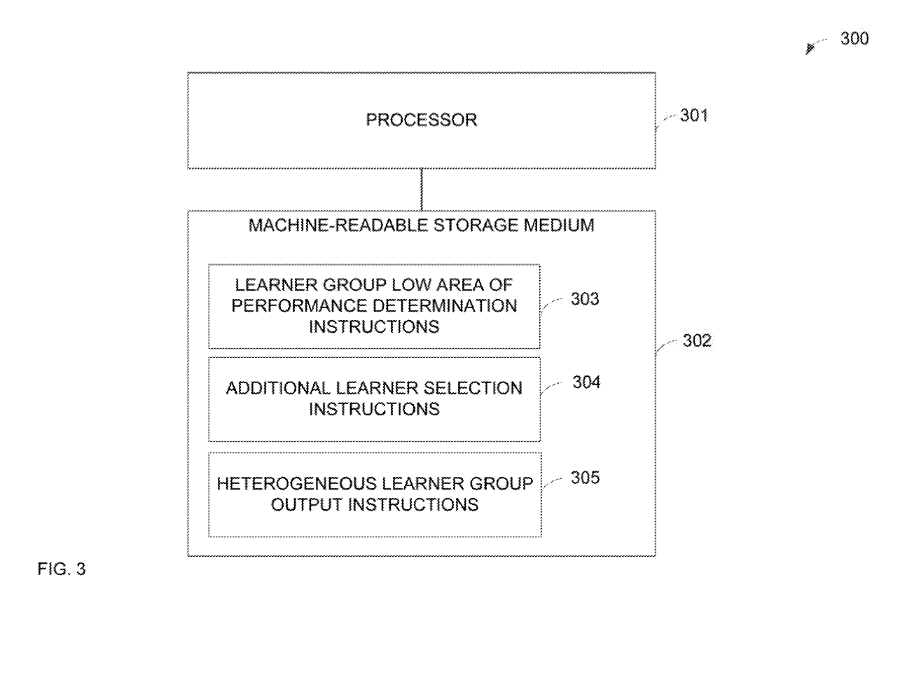

FIG. 3 is a block diagram illustrating one example of a computing system 300 to create a heterogeneous learner group based on historical performance data. For example, the heterogeneous learner group may include a leader learner with higher performance data in a particular area of weakness related to the group of learners. A processor may determine a weakness associated with the group of learners and a leader learner with an attribute that addresses the weakness. The computing system 300 includes a processor 301 and a machine-readable storage medium 302.

The processor 301 may be a central processing unit (CPU), a semiconductor-based microprocessor, or any other device suitable for retrieval and execution of instructions. As an alternative or in addition to fetching, decoding, and executing instructions, the processor 301 may include one or more integrated circuits (ICs) or other electronic circuits that comprise a plurality of electronic components for performing the functionality described below. The functionality described below may be performed by multiple processors.

The processor 301 may communicate with the machine-readable storage medium 302. The machine-readable storage medium 302 may be any suitable machine readable medium, such as an electronic, magnetic, optical, or other physical storage device that stores executable instructions or other data (e.g., a hard disk drive, random access memory, flash memory, etc.). The machine-readable storage medium 302 may be, for example, a computer readable non-transitory medium. The machine-readable storage medium 302 may include instructions executable by the processor 301, such as homogeneous learner group low area of performance determination instructions 303, additional learner selection instructions 304, and heterogeneous learner group output instructions 305.

The learner group low area of performance determination instructions 303 includes instructions to determine an area of low performance associated with a group of learners. For example, a test question answer, test score, or report card data may be used. The processor may have a threshold to identify a low area of performance, such as a value below a threshold, an area in the bottom N areas of performance for the group, and/or the bottom X percent areas of performance for the group.

The additional learner selection instructions 304 includes instructions to determine a learner with a higher value of performance in the particular area. For example, set of additional learners may be compared to one another to select an additional learner that has a higher performance in the particular area. Other factors may be considered in addition to the performance, such as where multiple potential additional learners to add to the group have a higher performance value in the particular area.

The heterogeneous learner group output instructions 305 includes instructions to create a heterogeneous learner group by adding the selected learner to the learner group and outputting information about the heterogeneous learner group. For example, information about the group may be stored, transmitted, or displayed. In one implementation, the computing system 300 recommends multiple sets of heterogeneous groups and allows a user to select a group.

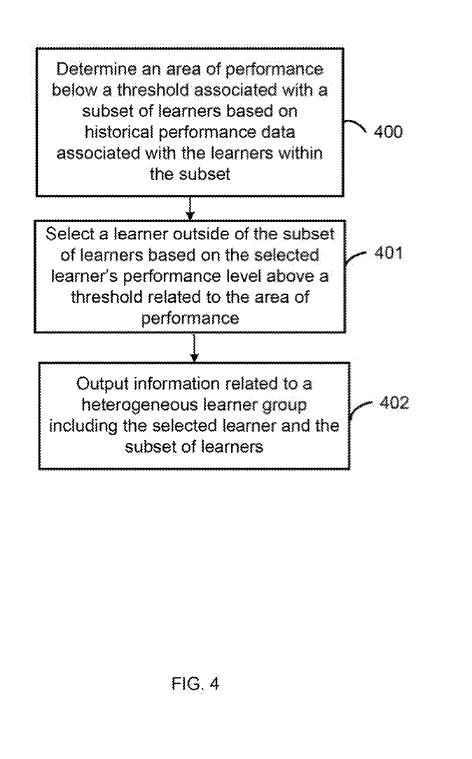

FIG. 4 is a flow, chart illustrating one example of a method to create a heterogeneous learner group based on historical performance data. For example the heterogeneous learner group may include at least a pair of learner's with different historical performance data where the first learner is considered to have a strength in an area of weakness of a second learner. The method may be implemented, for example, by the processor 401 of FIG. 4.

Beginning at 400, a processor determines an area of performance below a threshold associated with a subset of learners based on historical performance data associated with the learners within the subset. The area of performance may be, for example, an incorrect answer on a test exam, a set of questions with a percentage correct score below a threshold, or a report card grade in a subject below a threshold. In one implementation, the threshold may be determined by the relative performance in different areas, such as where the threshold is based on the lowest N areas of performance. There may be multiple low areas of performance identified. The area of performance may be individual information associated with the members of the group and/or aggregated performance information associated with the group as a whole. As an example, the area of performance below a threshold may include questions answered incorrectly on an evaluation by at least one of the learners within the subset.

Continuing to 401, a processor selects a learner outside of the subset of learners based on the selected learner's performance level above a threshold related to the area of performance. The threshold may be a standard threshold or set based on the low performance degree of the group, such as where any performance greater than the performance associated with the group or X percent higher than the performance of the group may be considered to, be above the threshold.

The learner may be selected according to any suitable method. For example, multiple groups may be created by selecting different learners to the group. The groups may be scored and the scores compared to select a group or set of groups. The processor may perform the learner selection recursively. For example, at each round of the recursion, the processor may select a learner that optimally addresses the weakness of the group and/or select a learner that marginally addresses the weakness of the group. In one implementation, multiple methods are performed to select potential learners to add to the group. Information about the potential groups may be provided to a user to select from the proposed groups and/or the processor may select between the proposed groups based on additional factors.

In one implementation, there are multiple areas of low performance associated with the group, such as where a list of questions answered incorrectly by any member of the group are identified as the areas of low performance. The processor may select from among a set of learners to add to the group based on the number or areas or area types addressed by each of the learners. For example, the learner may be selected based on addressing the highest number of performance areas, addressing performance areas given greater weight, and/or the degree to which the learner exceeds the threshold for a particular performance area.

In one implementation, a degree of reciprocity is determined. For example, the selected learner may be selected both on the degree to which the selected learner addresses a weakness associated with the group and the degree to which the group addresses a weakness associated with the selected learner. In one implementation, multiple potential groups are created, and the groups are scored based on the degree of reciprocity. The processor may select a group or subset of groups to recommend based on the degree of reciprocity.

The learner grouping and learner selection may be performed iteratively. For example, learners may be grouped based on a weakness determined according to historical performance data. The processor may attempt to identify a learner that addresses a weakness associated with the group. In cases where a learner is not identified, the processor may group the learners again and attempt to identify a learner to, add to each of the newly created groups. The processor may re-group the learners, such as using a different method or based on different factors, and attempt to select learners to associate with the new groups. In one implementation, the processor groups the learners and associates a selected learner with a first group but not a second and third group. The processor may re-group the learners in the second and third group to create new groups and select learners to add to address weaknesses of the newly created groups.

Continuing to 402, a processor outputs information related to a heterogeneous learner group including the selected learner and the subset of learners. The information may be output in any suitable manner, such as by storing, transmitting, or displaying information related to the members of the heterogeneous group. In one implementation, multiple heterogeneous groups are created, the processor selects at least one of the heterogeneous groups based on additional factors, such as the size of the heterogeneous group, the uniqueness of membership of the heterogeneous group, the number of additional learners added to the heterogeneous groups, and a comparison of the heterogeneous group to other heterogeneous groups. In one implementation, the additional factors are related to user provided constraints, such as a constraint that a particular pair of learners be in the same group or not be in the same group.

In one implementation, content is created and/or selected for the group. For example, the content may be selected to address a weakness associated with the group. In one implementation, different content is created for the selected learner and the additional learners.

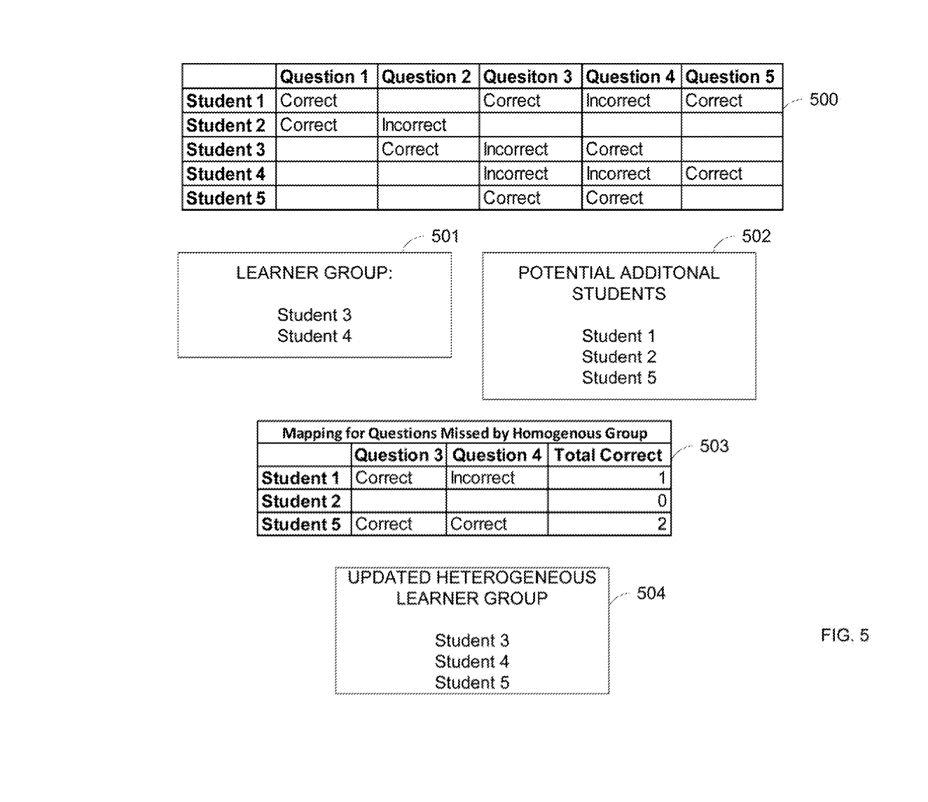

FIG. 5 is a diagram illustrating one example of creating a heterogeneous learner group based on historical performance data. Table 500 shows a chart with students 1 through 5 and their associated answers to questions 1 through 5, if any. For example, student 1 answered questions 1, 3, and 5 correctly and question 4 incorrectly, and student 2 answered question 1 correctly and question 2 incorrectly. Block 501 shows a learner group including student 3 and student 4. Block 502 shows the pool of additional students (students, 1, 2, and 5) to choose from to add to the learner group including students 3 and 4. Block 503 shows the list of questions missed by at least one of the students in the learning group, questions 3 and 4, and the correctness of the answers to those questions by the students in the additional pool of students. The total column shows that student 5 answered both correctly and that student 1 answered one correctly. Student 5 is selected based on a voting method selecting the student able to address the greatest number of weaknesses associated with the group. Block 506 shows the learner group of students 3 and 4 with added student 5.

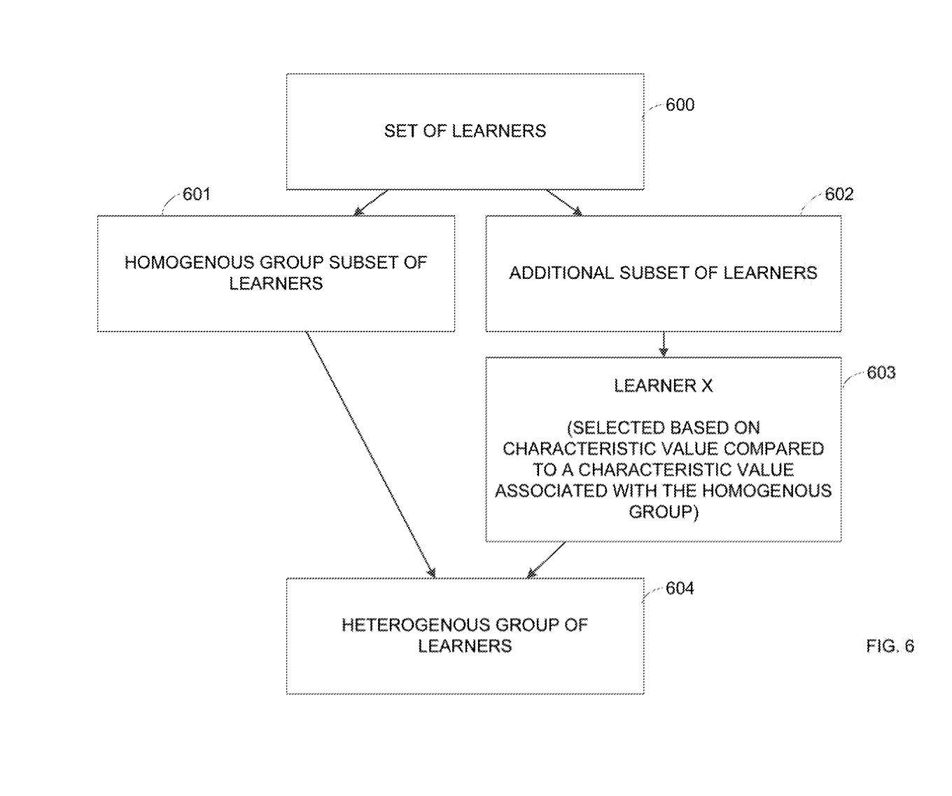

FIG. 6 is a diagram illustrating one example of creating a heterogeneous learner group from a homogeneous learner group. For example, a homogeneous group of learners may be selected using any suitable method for grouping, such as a a clustering method. The homogeneous grouping method may be used to group learners together within similar characteristics, such as similar weaknesses. Block 600 shows a set of learners. Block 601 shows a group of homogeneous learners. Block 602 shows an additional subset of learners from the set of learners in block 600 not included in the homogeneous group of learners in block 601. Block 603 shows a learner X selected from the additional subset of learners in block 602. For example, the learner X may be selected based on his ability to address weaknesses associated with the homogeneous group. Block 604 shows a heterogeneous group of learners created from the homogeneous subset of learners in block 601 and the additional learner X from block 603.

1. A computing system, comprising:
a processor to:
associate a selected learner with a group of learners based on a value of a factor associated with the group of learners compared to a value of the factor associated with the selected learner,
wherein the value associated with the selected learner is indicative of a strength compared to the value associated with, the group of learners; and
output information related to a heterogeneous learner group created from the group of learners and the selected learner.

2. The computing system of claim 1, wherein the value associated with the group is below a threshold and wherein the value associated with the selected learner is above a threshold.

3. The computing system of claim 1, wherein the factor is related to historical performance data.

4. The computing system of claim wherein the factor related to historical performance data relates to at least one of: the correctness of an answer to a particular test question, the correctness of an answers to a set of test questions, a test score, and a performance evaluation score.

5. The computing system of claim 4, wherein the processor determines multiple factors indicative of a weaknesses and selecting the learner comprises selecting the learner based on at least one of the number of factors and weight of the factors where the value associated with the selected learner is indicative of a strength.

6. The computing system of claim 1, wherein the processor further applies additional constraints when selecting the learner including at least one of: the size of the heterogeneous group, the uniqueness of membership of the heterogeneous group, the number of additional learners added to the heterogeneous groups, and a comparison of the heterogeneous group to other heterogeneous groups.

7. The computing system of claim 1, wherein the processor further adds the heterogeneous group to a set of heterogeneous groups based on a properties associated with the set of heterogeneous groups.

8. A method, comprising:
determining, by a processor, an area of performance below a threshold associated with a subset of learners based on historical performance data associated with the learners within the subset;
selecting a learner outside of the subset of learners based on the selected learner's performance level above a threshold related to the area of performance; and
outputting information related to a heterogeneous learner group including the selected learner and the subset of learners.

9. The method of claim 8, wherein the area of performance below a threshold includes a question answered incorrectly on an evaluation by at least one of the learners within the subset.

10. The method of claim 8, wherein determining an area performance comprises determining a first area of performance and determining a second area of performance; and
wherein selecting a learner comprises:
determining at least one of the number of areas of performance and the weight of the areas of performance for which the selected learner has a performance level above the threshold; and
selecting the learner based on the determination compared to a second learner outside of the subset of learners.

11. The method of claim 8, further comprising:
creating a second heterogeneous group; and
selecting whether to output the heterogeneous group or the second heterogeneous group based on a comparison of the heterogeneous groups.

12. The method of claim 8, further comprising:
determining a second area of performance below threshold associated with the selected learner, and
wherein selecting the learner comprises selecting the learner based on whether the performance of the group related to the second area of performance is above a threshold.

13. A computer readable non-transitory storage medium comprising ions executable by a processor to:
create a heterogeneous group of learners by selecting a learner to add to a homogeneous group of learners based on a factor used to, create the homogeneous, group of learners, the value of the factor associated with the homogeneous group, and the value of the factor associated with the added learner;
output information related to the created heterogeneous group.

14. The machine-readable non-transitory storage medium of claim 13, wherein the factor relates to historical performance data.

15. The machine-readable non-transitory storage medium of claim 14, wherein the factor comprises the correctness of a test question, the value associated with the homogeneous group is indicative of an incorrect answer, and the value associated with the selected learner is indicative of a correct answer.
